(19) United States
(12) Patent Application Publication
(10) Pub. No.: US 2014/0241702 A1
(43) Pub. Date: Aug. 28, 2014

(54) DYNAMIC AUDIO PERSPECTIVE CHANGE DURING VIDEO PLAYBACK

(71) Applicants: Ludger Solbach, Mountain View, CA (US); Carlo Murgia, Sunnyvale, CA (US)

(72) Inventors: Ludger Solbach, Mountain View, CA (US); Carlo Murgia, Sunnyvale, CA (US)

(21) Appl. No.: 14/189,817

(22) Filed: Feb. 25, 2014

Related U.S. Application Data
(60) Provisional application No. 61/769,061, filed on Feb. 25, 2013.

(51) Int. Cl. G11B 27/031; H04N 5/04

(52) U.S. Cl. CPC G11B 27/031; H04N 5/04
USPC 386/285

(57) ABSTRACT

Systems and methods for a dynamic audio perspective change during video playback are provided. A pre-recorded video is played with an associated raw audio signal. The audio signal is modified in real time based on an audio processing mode. The audio processing mode can be selected during the video playback via a graphic user interface. By selecting the audio processing mode, a user can attenuate one or more components of the pre-recorded raw audio signal. The components include near source sounds, distant source sounds, and a noise. After the desired audio processing mode is selected the entire audio signal is reprocessed according to the selected mode in a background process and stored in a memory.

### CROSS-REFERENCE TO RELATED APPLICATION

The present application claims the benefit of U.S. provisional application No. 61/769,061, filed on Feb. 25, 2013. The subject matter of the aforementioned application is incorporated herein by reference for all purposes.

### FIELD

The present application relates generally to audio processing and, more specifically, to systems and methods for providing dynamic audio change during audio and video playback.

### BACKGROUND

There are many audio and video recording systems that are operable to detect and record audio and/or video. While recording the video and/or audio, audio recording systems can introduce audio modifications by using filters, compression, noise suppression, and the like. Audio recording systems may be included in such portable devices as notebook computers, tablet computers, phablets, smart phones, personal digital assistants, media players, mobile telephones, pocket video recorders, and the like.

Audio recording systems are often misconfigured, which results in the recorded audio not capturing the desired acoustic scene or perspective.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to example embodiments of the present disclosure, audio recording systems may include one or more audio sensors such as microphones. Audio recording systems can be operable to perform real-time signal processing of acoustic signals received from the one or more sensors. The real-time signal processing can include filtering, compression, noise suppression, and the like. In some embodiments, the audio recording system may include a monitoring channel which allows a user to listen to the signal processed acoustic signal(s), for example a signal processed version of the original acoustic signal(s) when processing and recording the signal processed acoustic signal(s). The real-time signal processing may be performed while an audio recording system is recording and/or during playback.

Embodiments of the present invention allow storing raw or original acoustic signal(s) received by the one or more microphones. In some embodiments, signal processed acoustic signal(s) is stored. The original acoustic signal(s) can inherently include cues. Further cues can be determined during signal processing of the original acoustic signal(s), for example during recording, and stored with the original acoustic signals. Cues can include one or more of inter-microphone level difference, level salience, pitch salience, signal type classification, speaker identification, and the like. During the playback of recorded audio and, optionally, an associated video, the original acoustic signal(s) and/or recorded cues are used to alter the audio provided during the playback.

When recording the original acoustic signals(s) and, optionally, the signal processed acoustic signals, different audio modes (signal processing configurations) can be used to post-process the original acoustic signal(s) and create different audio directional and/or non-directional effects. A user listening and, optionally, watching to the recording may explore various options provided by different audio modes while continuing listening to the recording.

Some embodiments can allow a user to utilize an interface during the playback of the recorded audio and/or video. The user interface can include one or more controls, for example, buttons, icons, and the like for receiving control commands from the user during the playback. During the playback, the user can play, stop, pause, forward, and rewind the recorded audio and video. The user can also change the audio mode, for example, to reduce noise, focus on one or more sound sources, and the like, during the playback.

In some embodiments, the audio recording system may include faster than real-time signal processing. The audio recording system can be operable to process (in the background) the entire audio and video according to the last audio mode selected by the user.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram showing an example environment wherein the dynamic audio perspective change during video playback can be practiced.

FIG. 2 is a block diagram of an audio recording system that can implement a method for dynamic audio perspective change during a video playback, according to an example embodiment.

FIG. 3 is an example screen of a graphical user interface during a video playback.

FIG. 4 illustrates a table of audio processing mode details, according to some embodiments.

FIG. 5 is flowchart illustrating a method for dynamic audio perspective change during a video playback, according to an example embodiment.

FIG. 6 is example of a computing system implementing a method for dynamic audio perspective change during a video playback, according to an example embodiment.

### DETAILED DESCRIPTION

The present disclosure provides example systems and methods for dynamic audio perspective change during a video playback. Embodiments of the present disclosure may be practiced on any mobile device that is configurable to play a video and/or produce audio associated with the video, record an acoustic sound while recording the video, and store and process the acoustic sound and the video. While some embodiments of the present disclosure are described with reference to operations of a mobile device, like a mobile phone, a video camera, a tablet computer, the present disclosure may be practiced with any computer system having an audio and video device for playing and recording video and sound.

According to an example embodiment of the disclosure, a method for a dynamic audio perspective change during a video playback include playing, via speakers, an audio signal, and while playing the audio signal receiving a processing mode selected from a plurality of processing modes, and modifying the audio signal in a real time based on the processing mode. The audio signal can be previously recorded raw acoustic audio signal not modified by any pre-processing. The method can further include, while playing the audio signal, reprocessing the entire audio signal according to the processing mode in a background process and storing the reprocessed audio signal in a memory.

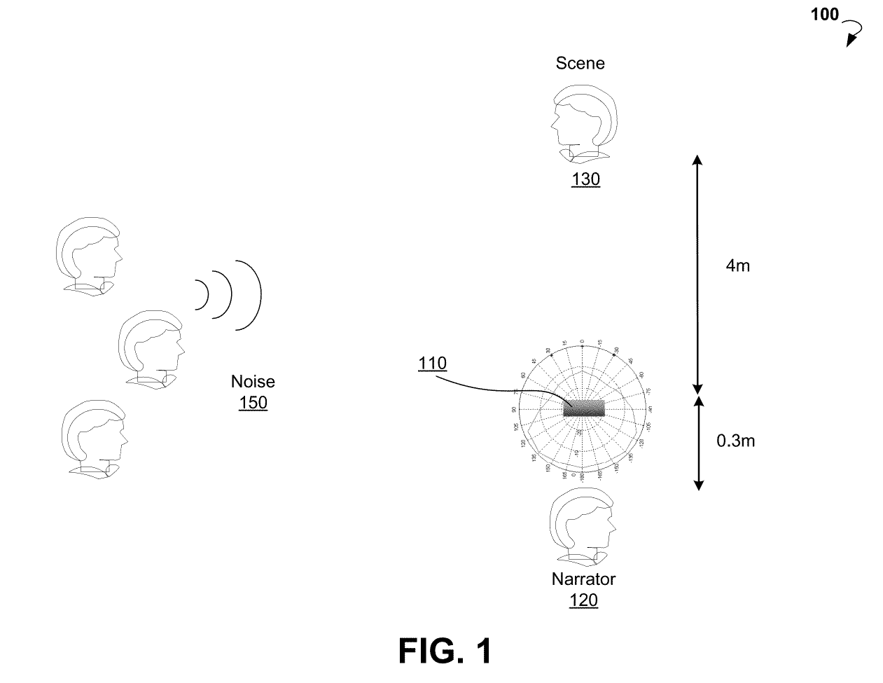

Referring now to FIG. 1, an environment 100 is shown, wherein a method for dynamic audio perspective change during a video playback can be practiced. In example environment 100, an audio recording system 110 is operable at least to, record an acoustic audio signal, process the recorded audio signal, and play back the recorded audio signal. In some embodiments, the audio recording system 110 can record a video associated with the audio signal. The example audio recording system 110 can include a mobile phone, a video camera, a tablet computer, and the like.

The acoustic audio signal recorded by the audio recording system 110 can include one or more of the following components: a near source (“narrator”) of acoustic sound (e.g., a speech of a person 120 who operates the audio recording system 110), and a distant source (e.g., a person 130 located in front of the audio recording system 110), in a direction opposite to the person 120 in the example in FIG. 1, the distance between the person 130 and the audio recording system 110 being larger than distance between the person 120 and the audio recording system 110. The person 130 can be captured on video. The sound coming from the near source and the distant source can be contaminated by a noise 150. The source of the noise 150 can be speech of other people, sounds of animals, automobiles, wind, and so forth.

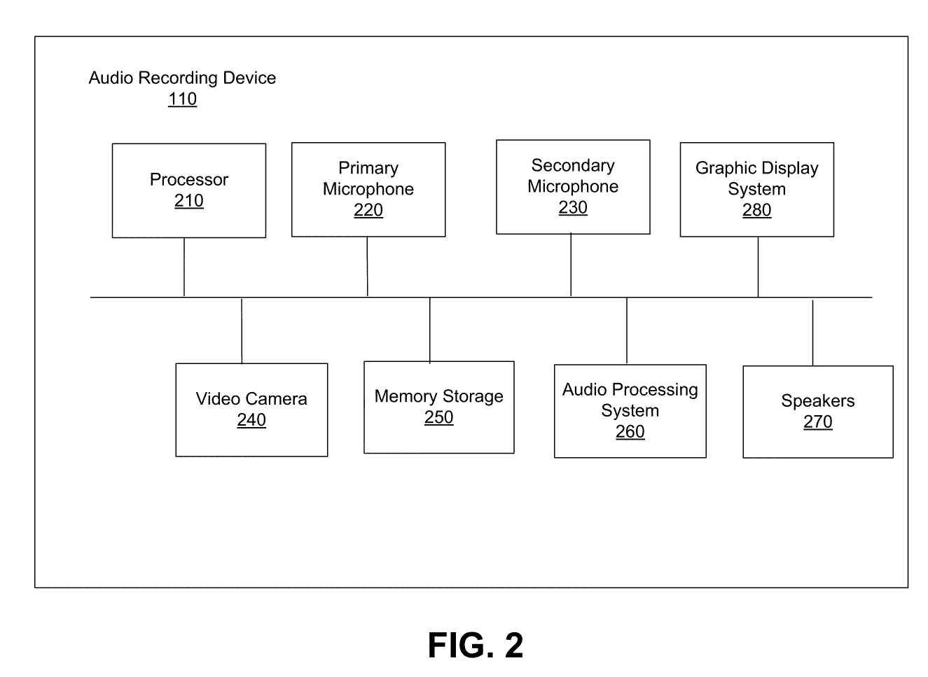

FIG. 2 is a block diagram of an example audio recording system 110. In the illustrated embodiment, the audio recording system 110 can include a processor 210, a primary microphone 220, one or more secondary microphones 230, video camera 240, memory storage 250, an audio processing system 260, speakers 270, and graphic display system 280. The audio recording system 110 may include additional or other components necessary for audio recording system 110 operations. Similarly, the audio recording system 110 may include fewer or additional components that perform similar or equivalent functions to those depicted in FIG. 2.

The processor 210 may include hardware and/or software, which is operable to execute computer programs stored in a memory storage 250. The processor 210 may use floating point operations, complex operations, and other operations, including dynamic audio perspective change during a video playback.

The video camera 240 is operable to capture still or moving images of an environment, from which the acoustic signal is captured. The video camera 240 generates a video signal associated with the environment, which includes one or more sound sources, for example a near talker, a distant talker and, optionally, one or more noise sources, for example, other talkers and machinery in operation. The video signal is transmitted to the processor 210 for storing in a memory storage 250 and further post-processing.

The audio processing system 260 may be configured to receive acoustic signals from an acoustic source via primary microphone 220 and optional secondary microphone 230 and process the acoustic signal components. The microphones 220 and 230 may be spaced a distance apart such that acoustic waves impinging on the device from certain directions exhibit different energy levels at the two or more microphones. After reception, by the microphones 220 and 230, the acoustic signals can be converted into electric signals. These electric signals can, in turn, be converted by an analog-to-digital converter (not shown) into digital signals for processing in accordance with some embodiments.

In various embodiments, where the microphones 220 and 230 are omni-directional microphones that are closely spaced (e.g., 1-2 cm apart), a beamforming technique can be used to simulate a forward-facing and a backward-facing directional microphone response. A level difference can be obtained using the simulated forward-facing and the backward-facing directional microphone. The level difference can be used to discriminate speech and noise in, for example, the time-frequency domain, which can be used in noise and/or echo reduction. In other embodiments, the audio recording system 110 may include extra directional microphones in addition to the microphones 220 and 230. The additional microphones and microphones 220 and 230 are directional microphones and can be arranged in rows and oriented in various directions.

It should be noted that audio processing system 260 can be configured to save a raw acoustic audio signal without any enhancement processing like noise and echo cancelation or attenuating or suppression of different components of the audio. The raw acoustic audio captured by microphones 220 and 230 and converted to digital signals can be saved in memory storage 250 for further post-processing while displaying the video on graphic display system 280 and playing audio associated with video via speakers 270. In some embodiments, the input cues, for example inter-microphone level differences (ILDs) between energies of the primary and secondary acoustic signals can be stored along with the recorded raw acoustic audio signal. In further embodiments, the input cues can include, for example, pitch salience, signal type classification, speaker identification, and the like. During the playback of the recorded audio signal and, optionally, an associated video, the original acoustic audio signal and recorded cues can be used to modify the audio provided during playback.

The graphic display system 280, in addition to playing back video, can be configured to provide a user graphic interface. In some embodiments, a touch screen associated with the graphic display system can be utilized to receive an input from a user. The options can be provided to a user via an icon or text buttons when the user touches the screen during the play back of the recorded video. In certain embodiments, a user can select one or more objects in the played video by clicking on an object or by drawing a geometrical figure, for example a circle or a rectangle, around the object. The selected object(s) can be associated with a corresponding sound source.

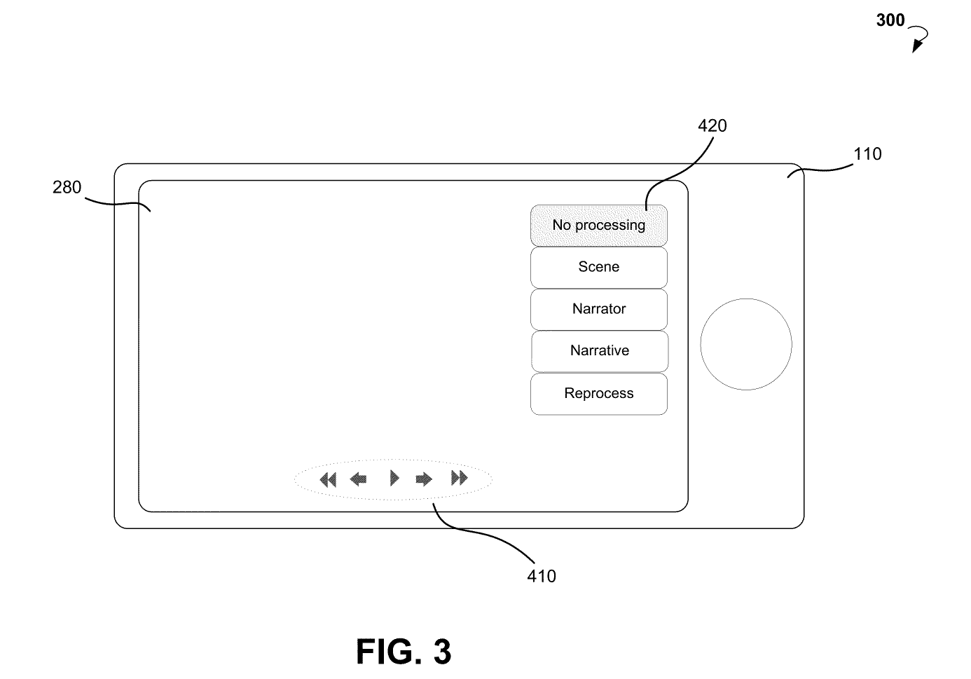

FIG. 3 is an example screen 300 showing options provided to the user during play back of the recorded video. The options can be provided via the graphic display system 280 of the audio recording system 110. During the playback, the user can play, stop, pause, forward, and rewind the recorded audio signal and associated video using standard “play/stop”, “rewind”, and “forward” buttons 410. In addition, during the playback, the user can change the audio mode, for example, to reduce noise, focus on one or more sound sources, and the like. One or more additional control or option buttons 420 are available to enable the user to control the playback and change to a different audio mode or toggle between two or more audio processing modes. For example, there can be one button corresponding to each audio mode. Pressing one of the buttons can select the audio mode corresponding to that button. In some embodiments, the user can select one or more objects in the played video in order to indicate to the audio recording system which sound source to focus on. The selection of the objects can be carried out by, for example, by double clicking on the object or by drawing a circle or another pre-determined geometrical figure around a portion of the video screen, the portion being associated with a desired sound source. In some further embodiments, after selecting a sound source in the video, a progress bar can be provided to the user via a graphical user interface. Using the progress bar, the user can set up a desirable level of volume for the selected sound source. In certain embodiments, the user can instruct the audio recording system to attenuate one or more sound sources in the played video by selecting the corresponding portion of the video on screen, for example, by drawing a “cross” sign or another pre-determined geometrical figure around the object associated with the undesired sound source.

A user can switch between different post processing modes while listening to the original or processed acoustic signals in real time to compare the perceived audio quality of the different audio modes. The audio processing modes can include different configurations of directional audio capture, for example, DirAc, Audio Focus, Audio Zoom, and the like and multimedia processing blocks, for example, bass boost, multiband compression, stereo noise bias suppression, equalization filters, and so forth. In some embodiments, the audio processing modes can enable a user to select an amount of noise suppression, direct an audio towards a scene, narrator, or both, and so forth.

In example screen 300 shown in FIG. 3, the buttons “No processing”, “Scene”, “Narrator”, “Narrative”, and “Reprocess” are available. By touching “No processing”, “Scene”, “Narrator”, or “Narrative” button, one of real-time audio processing modes can be selected. After a processing mode is selected, the audio recording system 110 can continue playing the audio modified to the selected mode. The audio signal being played is kept to be synchronized with an associated video.

The “scene” may, for example, include sound originating from one or more audio sources visible in the video for example, people, animals, machines, inanimate objects, natural phenomena, and so on. The “narrator” may, for example, include sound originating from the operator of the video camera and/or other audio sources not visible in the video, for example people, animals, machines, inanimate objects, natural phenomena, and the like.

By way of example and not limitation, a user can play a recording comprising audio and video portions. A user may touch or otherwise activate a screen during the playback by using, for example, buttons “rewind”, “play/pause”, “forward”, “Scene”, “Narrator”, and other buttons. When the user touches or otherwise activates the scene button, the audio recording system can be configured such that the video portion continues playing with a sound portion modified to provide an experience associated with the scene audio mode. The user may continue listening (and watching) the recording to determine whether the user prefers the scene audio mode. The user may optionally rewind the recording to an earlier time, if desired. Similarly, a user may touch or otherwise actuate a narrator button and, in response, the audio recording system is configured such that the video portion continues playing with a sound portion modified to provide an experience associated with the narrator audio mode. The user may continue listening to the recording to determine if the user prefers the narrator audio mode.

By way of further example and not limitation, if the user determines that the narrator audio mode is the mode in which the recording should be stored, the user presses a “reprocess” button, and the audio recording system can begin processing (in the background) the entire audio and video according to the last audio mode selected by the user. The user can continue listening/watching or can stop, for example, by exiting the application, while the process continues to completion (in the background). The user may track the background process status via the same or a different application.

The background process can be configured to optionally remove original microphones recordings associated with the original video in order to save space in memory storage 250. In some embodiments, the background process may optionally be configured to delete the stored original audio associated with the original video, for example, to save space in the audio recording system's memory. According to various embodiments, the audio recording system may also compress at least one of the audio signals, for example, the original acoustic signal(s), signal processed acoustic signal(s), acoustic signals corresponding to one or more of the audio modes, and so forth, for example, to conserve space in the audio recording system's memory. The user may upload the processed audio and video.

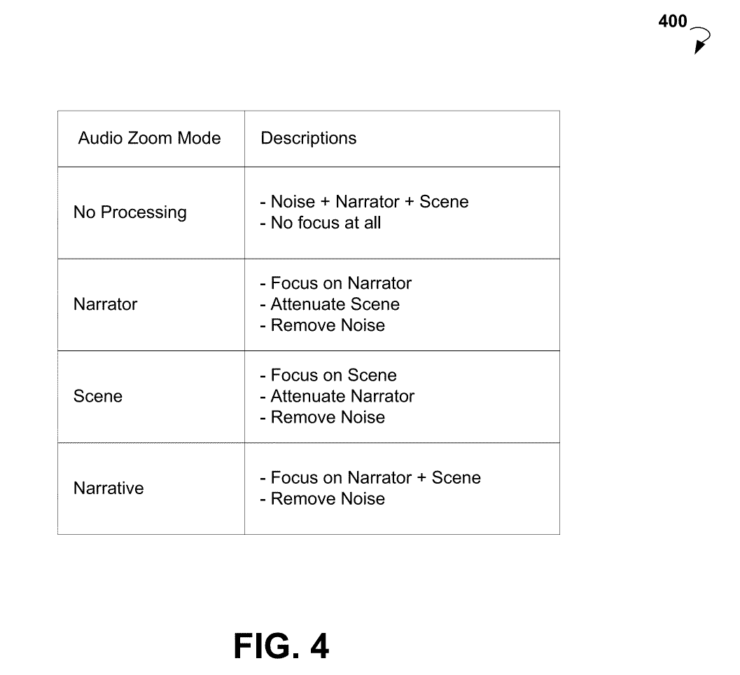

FIG. 4 shows a table 400 providing details of example audio processing modes that can be used to process audio associated with video played back by audio recording system 110. For example, the audio processing mode denoted as “No processing” indicates that the audio processing system cannot modify the played audio.

When the “Narrator” mode is selected, the audio processing system is configured to focus on a near source component (“narrator”) in played audio, suppress the noise component and attenuate a distant source component (“scene”).

When the “Scene” mode is selected, the audio processing system is configured to focus on a distant source component (“scene”), suppress the noise and attenuate the near source component (“narrator”).

When the “Narrative” mode is selected, the audio processing system is operable to focus on the near source component (“narrator”) and the distant source component (“scene”) and suppress the noise.

There may be a latency between the user pressing a button and a change in the audio mode, however in some embodiments, the lag may not be perceptible or may be acceptable to the user. For example, the delay may be about 100 milliseconds.

Attenuation of components and noise suppression can be carried out by the audio processing system 260 of the audio recording system 110 (shown in FIG. 2) based on input cues recorded with an original raw audio signal, like inter-microphone level difference, level salience, pitch salience, signal type classification, speaker identification, and so forth. In some embodiments, in order to suppress the noise an audio processing system may include a noise reduction module. An example audio processing system suitable for performing noise reduction is discussed in more detail in U.S. patent application Ser. No. 12/832,901, titled “Method for Jointly Optimizing Noise Reduction and Voice Quality in a Mono or Multi-Microphone System, filed on Jul. 8, 2010, the disclosure of which is incorporated herein by reference for all purposes.

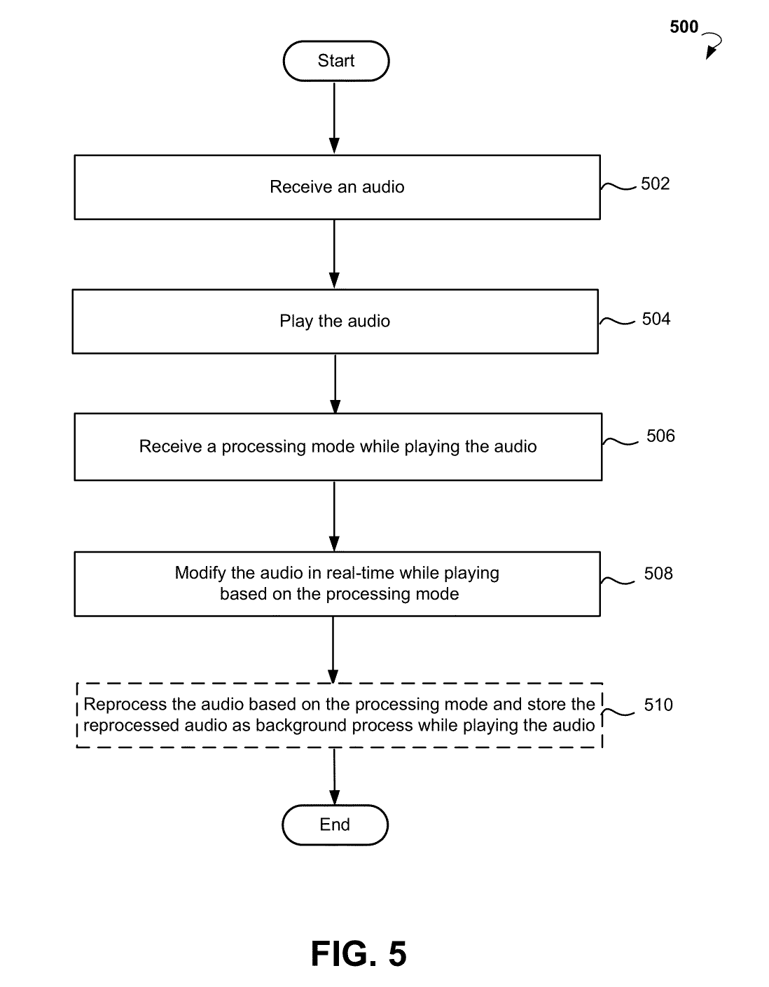

FIG. 5 is flow chart diagram showing steps of method 500 for dynamic audio perspective change during video playback, according to an example embodiment. The steps of the example method 500 can be carried out using the audio recording system 110 shown in FIG. 2. The method 500 may commence in step 502 with receiving an audio, the audio being an original acoustic signals recorded along with an associated video. In step 504, the method 500 continues with playing the audio. In step 506, a processing mode is received while playing the audio. In step 508, the audio being played can be modified in real time in response to the processing mode. In optional step 510, the entire audio can be reprocessed according to the processing mode and stored in memory in background process while continuing playing the audio.

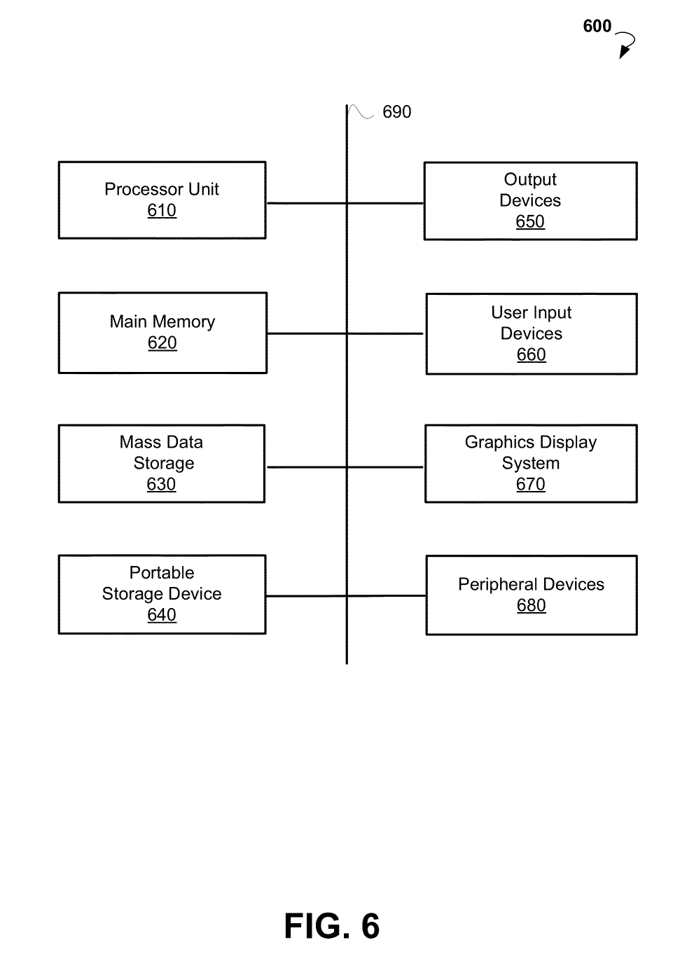

FIG. 6 illustrates an example computing system 600 that may be used to implement embodiments of the present disclosure. The system 600 of FIG. 11 can be implemented in the contexts of the likes of computing systems, networks, servers, or combinations thereof. The computing system 600 of FIG. 6 includes one or more processor units 610 and main memory 620. Main memory 620 stores, in part, instructions and data for execution by processor 610. Main memory 620 stores the executable code when in operation. The system 600 of FIG. 6 further includes a mass data storage 630, portable storage device(s) 640, output devices 650, user input devices 660, a graphics display 670, and peripheral devices 680.

The components shown in FIG. 6 are depicted as being connected via a single bus 690. The components may be connected through one or more data transport means. Processor unit 610 and main memory 620 is connected via a local microprocessor bus, and the mass data storage 630, peripheral device(s) 680, portable storage device 640, and display system 670 are connected via one or more input/output (I/O) buses.

Mass data storage 630, which can be implemented with a magnetic disk drive, solid state drive, or an optical disk drive, is a non-volatile storage device for storing data and instructions for use by processor unit 610. Mass data storage 630 stores the system software for implementing embodiments of the present disclosure for purposes of loading that software into main memory 620.

Portable storage device 640 operates in conjunction with a portable non-volatile storage medium, such as a floppy disk, compact disk, digital video disc, or Universal Serial Bus (USB) storage device, to input and output data and code to and from the computer system 600 of FIG. 6. The system software for implementing embodiments of the present disclosure is stored on such a portable medium and input to the computer system 600 via the portable storage device 640.

Input devices 660 provide a portion of a user interface. Input devices 660 include one or more microphones, an alphanumeric keypad, such as a keyboard, for inputting alphanumeric and other information, or a pointing device, such as a mouse, a trackball, stylus, or cursor direction keys. Input devices 660 can also include a touchscreen. Additionally, the system 600 as shown in FIG. 6 includes output devices 650. Suitable output devices include speakers, printers, network interfaces, and monitors.

Graphics display system 670 include a liquid crystal display (LCD) or other suitable display device. Graphics display system 670 receives textual and graphical information and processes the information for output to the display device.

Peripheral devices 680 may include any type of computer support device to add additional functionality to the computer system.

The components provided in the computer system 600 of FIG. 6 are those typically found in computer systems that may be suitable for use with embodiments of the present disclosure and are intended to represent a broad category of such computer components that are well known in the art. Thus, the computer system 600 of FIG. 6 can be a personal computer (PC), hand held computing system, tablet, phablet telephone, smartphone, mobile computing system, workstation, server, minicomputer, mainframe computer, or any other computing system. The computer may also include different bus configurations, networked platforms, multi-processor platforms, and the like. Various operating systems may be used including UNIX, LINUX, WINDOWS, MAC OS, PALM OS, ANDROID, IOS, QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a Compact Disk Read Only Memory (CD-ROM) disk, digital video disk (DVD), BLU-RAY DISC (BD), any other optical storage medium, Random-Access Memory (RAM), Programmable Read-Only Memory (PROM), Erasable Programmable Read-Only Memory (EPROM), Electronically Erasable Programmable Read Only Memory (EEPROM), flash memory, and/or any other memory chip, module, or cartridge.

Thus systems and methods for dynamic audio perspective change during video playback have been disclosed. Present disclosure is described above with reference to example embodiments. Therefore, other variations upon the example embodiments are intended to be covered by the present disclosure.

What is claimed is:

1. A method for a dynamic audio perspective change, the method comprising:
playing, via speakers, an audio signal, the audio signal being previously recorded, wherein while playing the audio signal:
receiving a processing mode from a plurality of processing modes;
and
modifying the audio signal in real time based on the processing mode.

2. The method of claim 1, wherein the audio signal is associated with a video, the video being played synchronously with the audio signal.

3. The method of claim 1, wherein the audio signal comprises one or more of the following components: a near source sound, a distant source sound, and a noise.

4. The method of claim 3, wherein the processing mode is associated with attenuating the one or more components of the audio signal.

5. The method of claim 3, wherein the processing mode is associated with focusing on the one or more components of the audio signal.

6. The method of claim 3, wherein the audio signal includes a directional audio signal previously recorded using two or more microphones.

7. The method of claim 1, wherein the processing mode is received via a graphic user interface.

8. The method of claim 1, wherein while playing the audio signal, if the processing mode is changed to a second processing mode selected from the plurality of the processing modes, modifying the audio signal in real time based on the second processing mode.

9. The method of claim 1, further comprising, while playing the audio signal, reprocessing the audio signal, in a background process, according to the processing mode.

10. The method of claim 9, further comprising storing the reprocessed audio signal in a memory.

11. A system for a dynamic audio perspective change, the system comprising at least:
one or more speakers;
a user interface; and
an audio processor; and
configured to:
play, via the one or more speakers, an audio signal, the audio signal being previously recorded, and while playing the audio signal:
receive, via the user interface, a processing mode from a plurality of processing modes; and
modify, via the audio processor, the audio signal in real time based on the processing mode.

12. The system of claim 11, wherein the audio signal is associated with a video, the video being played synchronously with the audio signal.

13. The system of claim 11, wherein the audio signal comprises one or more components including a near source sound, a distant source sound, and a noise.

14. The system of claim 13, further comprising two and more microphones and wherein the audio signal includes a directional audio signal previously recorded using the two or more microphones.

15. The system of claim 13, wherein the processing mode is associated with attenuating the one or more components of the audio signal.

16. The system of claim 13, wherein the processing mode is associated with focusing on the one or more component of the audio signal.

17. The system of claim 11, wherein the processing mode is received via the user interface provided by a graphic display.

18. The system of claim 11, wherein while playing the audio signal, if the processing mode is changed to a second processing mode selected from the plurality of the processing modes, the system is further configured to modify the audio signal in real time based on the second processing mode.

19. The method of claim 11, wherein while playing the audio, the signal is reprocessed according to the processing mode in a background process.

20. A non-transitory computer readable medium having embodied thereon a program, the program providing instructions for a method for a dynamic audio perspective change, the method comprising:
playing, via speakers, an audio, the audio signal being previously recorded, and while playing the audio signal:
receiving a processing mode from a plurality of processing modes;
and
modifying the audio signal in real time based on the processing mode.
